(19) United States
(12) Patent Application Publication
(10) Pub. No.: US 2016/0117945 A1
(43) Pub. Date: Apr. 28, 2016

(54) USE OF FORCE TRAINING SYSTEM IMPLEMENTING EYE MOVEMENT TRACKING

(71) Applicant: Ti Training Corp., Golden, CO (US)

(72) Inventors: Gregory Otte, Golden, CO (US); Todd R. Brown, Golden, CO (US); Joseph J. Mason, Golden, CO (US)

(21) Appl. No.: 14/923,185

(22) Filed: Oct. 26, 2015

Related U.S. Application Data
(60) Provisional application No. 62/068,060, filed on Oct. 24, 2014.

(51) Int. Cl. G09B 9/00; G09B 5/02

(52) U.S. Cl. CPC G09B 9/003; G09B 5/02

(57) ABSTRACT

A use of force training system is described. Embodiments of the use of force training system can include a weapon, a simulator system, and an eye tracking device. Typically, a trainee can be outfitted with the weapon and the eye tracking device. The eye tracking device can be implemented to track where the trainee is focusing while interacting with a training scenario. Typically, an instructor can provide feedback to the trainee based on information provided by the eye tracking device in a use of force simulation setting. In some embodiments, the simulator system can be adapted to alter a training scenario based on data received from the eye tracking device.

### CROSS-REFERENCE TO RELATED APPLICATION

This application claims the benefit of U.S. Provisional Application No. 62/068,060, filed Oct. 24, 2014.

### BACKGROUND

Currently, use of force simulators are implemented to train users in handling of weapons in real life scenarios. Use of force simulators are typically used by law enforcement agencies to provide real life training to police officers. The use of force simulator is a valuable tool in helping train users how to properly use their firearms and/or non-lethal weapons in a variety of situations.

Use of force simulators are also used to train users in proper procedure when dealing with a threat. For example, the use of force simulator can present scenarios where a user must correctly interact with the scenario or the scenario may branch to a video of the user being shot at. Alternatively, the scenario may branch to a video of a bystander being injured based on actions of the user.

Current use of force simulators are limited in their ability to provide total feedback to a user. More specifically, current simulators are not able to determine where a user was focusing while watching and/or interacting with the scenario. Current use of force simulators are further limited to only be able to automatically react based on detecting where a user fired a training weapon. More productive training would be achieved if more metrics could be measured, recorded, and analyzed.

Therefore, there is a need for a use of force simulator with advanced measurable metrics over the currently available use of force simulators.

### BRIEF DESCRIPTION OF THE DRAWINGS

FIG. 1A is a block diagram of a use of force training system according to one embodiment of the present invention.

FIG. 1B is a block diagram of a simulator system according to one embodiment of the present invention.

FIG. 1C is a block diagram of a weapon according to one embodiment of the present invention.

FIG. 2A is a front view of an eye tracking device according to one embodiment of the present invention.

FIG. 2B is a back view of an eye tracking device according to one embodiment of the present invention.

FIG. 2C is a graphical representation of a point-of-view marker according to one embodiment of the present invention.

FIG. 3 is a flow chart illustrating a first method of implementing a use of force training system according to one embodiment of the present invention.

FIG. 4 is a flow chart illustrating a second method of implementing a use of force training system according to one embodiment of the present invention.

FIG. 5 is a flow chart illustrating a third method of implementing a use of force training system according to one embodiment of the present invention.

FIG. 6 is a flow chart illustrating a method of implementing a simulator system to automatically branch a training scenario according to one embodiment of the present invention.

FIG. 7 is a block diagram of a use of force training system according to one embodiment of the present invention.

### DETAILED DESCRIPTION

Embodiments of the present invention include a use of force training system that implements one or more eye tracking devices. Typically, the use of force training system can include, but is not limited to, a weapon, a simulator system, and an eye tracking device. The weapon and the eye tracking device can be operatively coupled to the simulator system. For instance, the simulator system can be adapted to detect pulses of light generated by the weapon and receive data from the eye tracking device. In one embodiment, the use of force training system can include a plurality of eye tracking devices. It is to be appreciated that the eye tracking devices can be hardwired and/or wirelessly connected to the simulator system.

In one embodiment, the simulator system can include, but is not limited to, a life size screen, a projector, a control module, a monitor, a sensor, and a network interface. It is to be appreciated that the life size screen may be about life size. Typically, the control module can be operatively coupled to the projector, the monitor, and the sensor. The control module can be adapted to run specific use of force software that is displayed on the monitor. The control module can be further implemented to run training scenarios that are output to the projector to be displayed on the life size screen.

The simulator system can be implemented to store and present interactive training scenarios to one or more trainees. Typically, a trainee can be presented various simulated scenarios where they may be called upon to use force. For instance, the training scenario may call for the trainee to use a firearm and/or a non-lethal weapon. Typically, the simulator system can include a life size (or near life size) screen on to which a training scenario can be projected. The simulator system can include specialized software utilized to cause a training scenario video to branch from one video segment to another video segment depending on the actions of the trainee interacting with the training scenario. For instance, if the trainee fires the weapon, the training scenario might branch to reflect a hit or miss. In other instances, an instructor operating and controlling the training scenario might cause the training scenario to branch based on behavior the trainee exhibits relative to the training scenario.

Typically, the weapon can be equipped (or outfitted) with a laser. The laser can be operatively coupled to a trigger of the weapon. When the trigger is pulled, the laser can be activated. The simulator system can include the sensor to detect the light pulse generated by the laser. The simulator system can typically include software that implements the sensor to detect where the laser hit and then determine if the laser was in a specified area to indicate a hit or miss.

The eye tracking device can be adapted to provide a point-of-view video and track eye movement of a wearer of the eye tracking device. Currently, eye tracking glasses are known that can track the movement of a wearer's eyes. In one instance, eye tracking glasses can implement optical sensors (e.g., cameras) on a backside of a frame that can sense movement of a wearer's pupils and can either wirelessly (or through a wired connection) provide eye movement data to the control module running software. Other eye tracking glasses are known wherein a positioning of the pupils is interfaced with a camera located on a front of the glasses that can identify and broadcast what a wearer is looking at.

In one embodiment, wireless Eye Tracking Glasses 2 (or ETG 2) made by SensoMotoric Instruments GmbH of Teltow, Germany can be implemented in the use of force training system. The ETG 2 glasses incorporate cameras that can track a wearer's pupil positions and correlate a point or region of a wearer's focus to a point or region associated with a video feed from an outwardly facing camera located on the bridge of the glasses. Typically, software used in conjunction with the ETG 2 glasses can generate a superimposed circle icon that indicates where a wearer is focusing. The icon can move with the wearer's eyes as their focus shifts from one object or item to another.

In a typical implementation, a trainee can be run through a training scenario. Based on his interaction with the training scenario, the training scenario can be branched to provide different outcomes. Once a training scenario is complete, a trainer or instructor, who typically runs the training scenario from the simulator system control module, can debrief the trainee. The debriefing can include, but is not limited to, discussing a performance of the trainee, reviewing of data and/or metrics, and reviewing video recorded during the running of the training scenario.

In one embodiment, video generated from the eye tracking device can be recorded and saved by the simulator system. Software included with the simulator system can synchronize video from the eye tracking device with video of the training scenario as the training scenario is branched in response to the actions of the trainee. In some embodiments, the software can include the capability of replaying both the training scenario and the video from the eye tracking device indicating a wearer's focus simultaneously in a picture-in-picture format, on separate monitors, or in a split-screen format. Advantageously, the instructor and the trainee can review whether the trainee's focus was properly directed and whether the trainee's focus negatively impacted the trainee's response to the stimuli provided in the training scenario.

In some embodiments, the instructor can monitor what the trainee is looking at while the training scenario is being played. In one instance, the instructor can watch a picture-in-picture real time video feed from the eye tracking device. Based on monitoring the real time video feed, the instructor can intervene in the training scenario and actuate a particular branch to a different video segment included in the training scenario. For example, if the trainee is focused on something other than a threat in a training scenario, the instructor may initiate a branch wherein the threat behaves in a manner consistent with the trainee (who may represent a law enforcement officer) looking away or not paying attention to the threat's actions.

In yet other embodiments, data obtained from the eye tracking device, and more specifically from the cameras facing a trainee's eyes, can be calibrated with the life size screen. Once calibrated, the location of the trainee's focus can be ascertained relative to the training scenario in real time by the simulator system. Branching of the training scenario can be automatically triggered by the software without instructor intervention. For instance, the software can have predetermined parameters that when met, act similar to where a training scenario is branched in response to a simulated discharge of a firearm and the associated hit detection at specific locations within the training scenario. For example, if the training scenario presents a distraction within the training scenario and the trainee diverts their attention from a real threat, the threat (or suspect) may take an action such as run away or draw their gun.

In one embodiment, video captured from the front facing camera of the eye tracking device along with data and/or superimposed icon indicating a focus of the trainee's gaze can be fed to and recorded by the simulator system during the running of a training scenario. Upon completion of the training scenario, a video of the training scenario as the training video played out with the trainee's interaction can be replayed simultaneously with the video from the eye tracking device. Typically, the videos can be played on one or both an associated monitor or the life size or near life size screen.

Based on the video, the instructor can offer commentary and/or advice as to what the trainee did correctly or incorrectly during the running of the training scenario. In one instance, an instructor views the video feed of the trainee's gaze and triggers a branching of the training scenario based on what the trainee is looking at. In another instance, the simulator system can automatically trigger a branching of the training scenario based on what the trainee is looking at.

Feedback from the instructor and the use of force training system can include, but is not limited to, accuracy of a shot by a trainee, reaction times of the trainee, and actions performed by the trainee during the training scenario. In other instances, the trainee and instructor can review where the trainee was focused during firing of a weapon to help aid the trainee in becoming more proficient and accurate when firing the weapon. For instance, the instructor may notice that the trainee's focus is on the end of the weapon in lieu of focusing on the target the trainee is aiming at. It is to be appreciated that embodiments of the present invention can be implemented to track and analyze weapon proficiency metrics to aid in training on a particular weapon.

Various enhancements to the use of force training system can be made to enhance and improve the training experience. For instance, a return fire cannon that fires paintballs or other projectiles may be incorporated to simulate return fire. The trainee may be called upon to wear a vest that notifies him by shock, lights, and/or other means that he has been hit. Additional cameras may be employed to record the activity of the trainee for review thereafter.

As can be appreciated the embodiments are described relative to a single user. It is appreciated that when multiple users are simultaneously interacting in a scenario that embodiments of the invention permit the simultaneous use of a plurality of eye tracking devices and weapons.

U.S. patent application Ser. No. 14/597,464, filed Jan. 15, 2015 and U.S. patent application Ser. No. 13/964,683, filed Aug. 12, 2013 are hereby both incorporated in their entirety by reference.

U.S. Pat. No. 8,398,239, issued Mar. 19, 2013; U.S. Pat. No. 9,107,622, issued Aug. 18, 2015; U.S. Pat. No. 7,391,887, issued Jun. 24, 2008; U.S. Pat. No. 8,342,687, issued Jan. 1, 2013; US publication 2014/0146156, published May 29, 2014; and US publication 2011/0279666, published Nov. 17, 2011 are all hereby incorporated in their entirety by reference.

### TERMINOLOGY

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The terms “couple” or “coupled,” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally,” “near,” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

The term “software,” as used in this specification and the appended claims, refers to programs, procedures, rules, instructions, and any associated documentation pertaining to the operation of a system.

The term “firmware,” as used in this specification and the appended claims, refers to computer programs, procedures, rules, instructions, and any associated documentation contained permanently in a hardware device and can also be flashware.

The term “hardware,” as used in this specification and the appended claims, refers to the physical, electrical, and mechanical parts of a system.

The terms “computer-usable medium” or “computer-readable medium,” as used in this specification and the appended claims, refers to any medium that can contain, store, communicate, propagate, or transport the program for use by or in connection with the instruction execution system, apparatus, or device. The computer-usable or computer-readable medium can be, for example but not limited to, an electronic, magnetic, optical, electromagnetic, infrared, or semiconductor system, apparatus, device, or propagation medium. By way of example, and not limitation, computer readable media can comprise computer storage media and communication media.

The term “signal,” as used in this specification and the appended claims, refers to a signal that has one or more of its characteristics set or changed in such a manner as to encode information in the signal. It is to be appreciated that wireless means of sending signals can be implemented including, but not limited to, Bluetooth, Wi-Fi, acoustic, RF, infrared and other wireless means.

The term “disruptor device,” as used in this specification and the appended claims, refers to a conducted electrical weapon (CEW) including, but not limited to, an electroshock weapon, stun gun, and electronic control device.

The term “live cartridge” or “live cartridges,” as used in this specification and the appended claims, refer to single use cartridges generally containing a propellant and two wire-tethered electrodes for use with a conducted electrical weapon.

The term “weapon,” as used in this specification and the appended claims, refers to, but is not limited to, a firearm, a gun, a rifle, a shotgun, a pistol, a handgun, a disruptor device, and a conducted electrical weapon.

The term “training scenario,” as used in this specification and the appended claims, refers to an interactive training video including a plurality of video segments. The training scenario can be adapted to branch from video segment to video segment based on input from an instructor or software.

The term “point-of-focus marker” or “gaze point,” as used in this specification and the appended claims, refers to a graphic marker or icon generated by compiling data from an eye tracking device. The point-of-focus marker correlates to a point-of-focus of a wearer of the eye tracking device and can show where a wearer's focus was while wearing the eye tracking device. The term's point-of-focus marker and gaze point can be used interchangeably.

### A First Embodiment of a Use of Force Training System

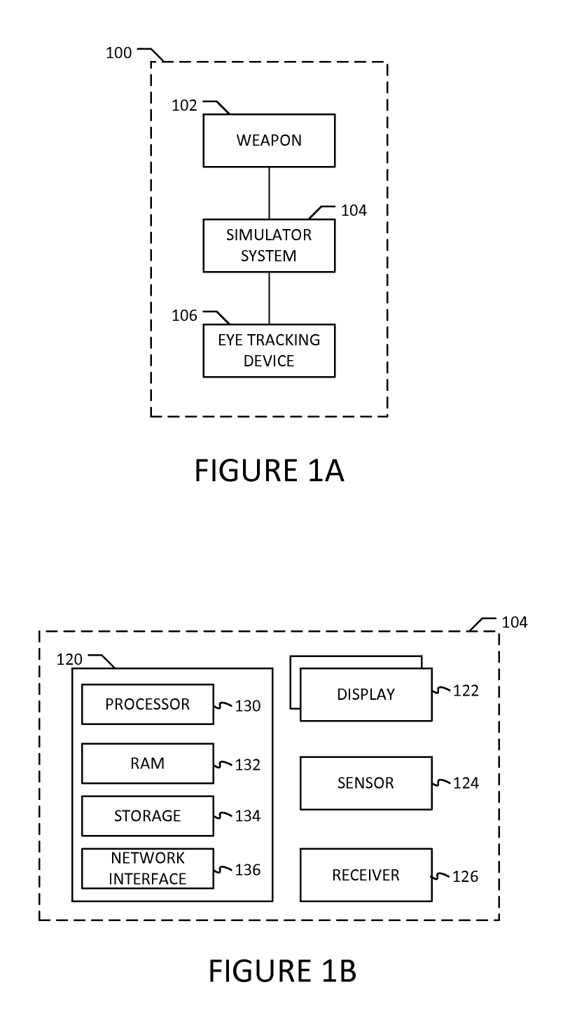

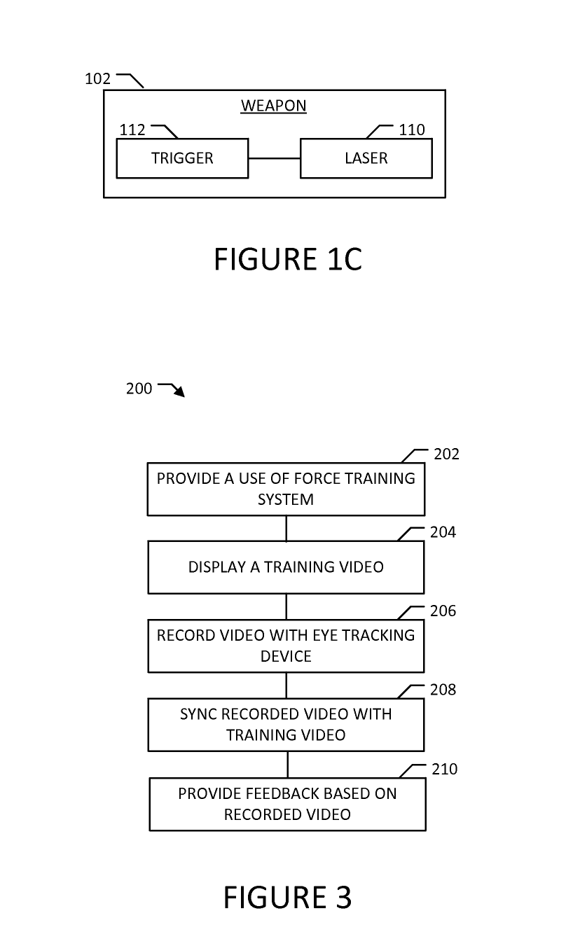

Referring to FIG. 1A, a block diagram of a first embodiment 100 of a use of force training system is illustrated. Generally, the use of force training system 100 can be implemented for training users on how to properly use a weapon. In one embodiment, the training system 100 can be implemented to train a plurality of users, where each of the users has at least one weapon.

The use of force training system 100 can generally include a weapon 102, a simulator system 104, and an eye tracking device 106. In some embodiments, the use of force training system 100 can include two or more weapons and two or more eye tracking devices.

As shown in FIG. 1C, the weapon 102 can include, but is not limited to, at least one laser 110 and a trigger 112. It is to be appreciated that the number of lasers can be dependent on the type of weapon. For instance, a firearm will typically have one laser, while a disruptor device will typically have two lasers. The laser 110 can be adapted to generate a pulse of light with a wavelength in the infrared spectrum in response to the trigger 112 being pulled. For example, the laser 110 can generate a pulse of light with a wavelength of 785 nm plus or minus 50 nm. Typically, lasers adapted to generate pulses of light not visible to a human are implemented including, but not limited to, infrared spectrum lasers. It is to be appreciated that other means of generating light waves in the non-visible light spectrum can be implemented without exceeding the scope of the present invention. Generally, the laser 110 can be unidirectional and can typically be registered by the simulator system 104 when the laser beam is projected on a display of the simulator system 104.

Referring to FIG. 1B, a block diagram of the simulator system 104 is illustrated. As shown, the simulator system 104 can include, but is not limited to, a control module 120, one or more displays 122, a sensor 124, and a receiver 126. The control module 120 can be adapted to run a program or application which can decipher signals received by the sensor 124 and the receiver 126. In some embodiments, as will be discussed hereinafter, the control module 120 can run a program or application specifically designed for the eye tracking device 106. Further, the control module 120 can be implemented to play training scenario videos.

The control module 120 can typically include, but is not limited to, a processor 130, a random access memory 132, a nonvolatile storage 134 (or memory), and a network interface 136. The processor 130 can be a single microprocessor, multi-core processor, or a group of processors. The random access memory 132 can store executable code as well as data that may be immediately accessible to the processor 130, while the nonvolatile storage 134 can store executable code and data in a persistent state. The network interface 136 can include hardwired and wireless interfaces through which the control module 120 can communicate with other devices and/or networks.

Typically, the simulator system 104 can include a first display and a second display. In one instance, the first display can be a combination of a digital projector and a substantially life size display screen and the second display can be a monitor for the control module 120. The one or more displays 122 can include, but are not limited to, a liquid crystal display, a plasma display panel, a light-emitting diode display, and a digital projector. Typically, a digital projector can be implemented to project onto the life size display screen. Other display devices are contemplated including, but not limited to, head-mounted displays and optical head-mounted displays.

The sensor 124 can be implemented to detect pulses of light generated by the laser 110. In one embodiment, the sensor 124 can be a camera connected to the control module 120. The receiver 126 can include, but is not limited to, a universal serial bus receiver. In one embodiment, the USB receiver 126 can be connected to the simulator system 104 through a universal serial bus port of the control module 120. The USB receiver 126 can be configured to receive a signal transmitted by an emitter. For example, where the weapon 102 is a conducted electrical weapon, a training cartridge inserted into the conducted electrical weapon may include an emitter.

The simulator system 104 can typically store a plurality of training scenarios in the nonvolatile storage 134. When a training scenario is ready to be played, the simulator system 104 can play the training scenario on the first display. Generally, each of the plurality of training scenarios can include at least two videos. A first video can start a scenario and the training scenario can include one or more additional videos to be branched to based on actions of a trainee. For instance, a first video of the training scenario may show a perpetrator appearing to be aggressive after being pulled over. Depending on how the trainee reacts, the simulator system 104 can branch the training scenario from the first video to a second video showing the perpetrator backing down in reaction to the trainee showing a capability for use of force.

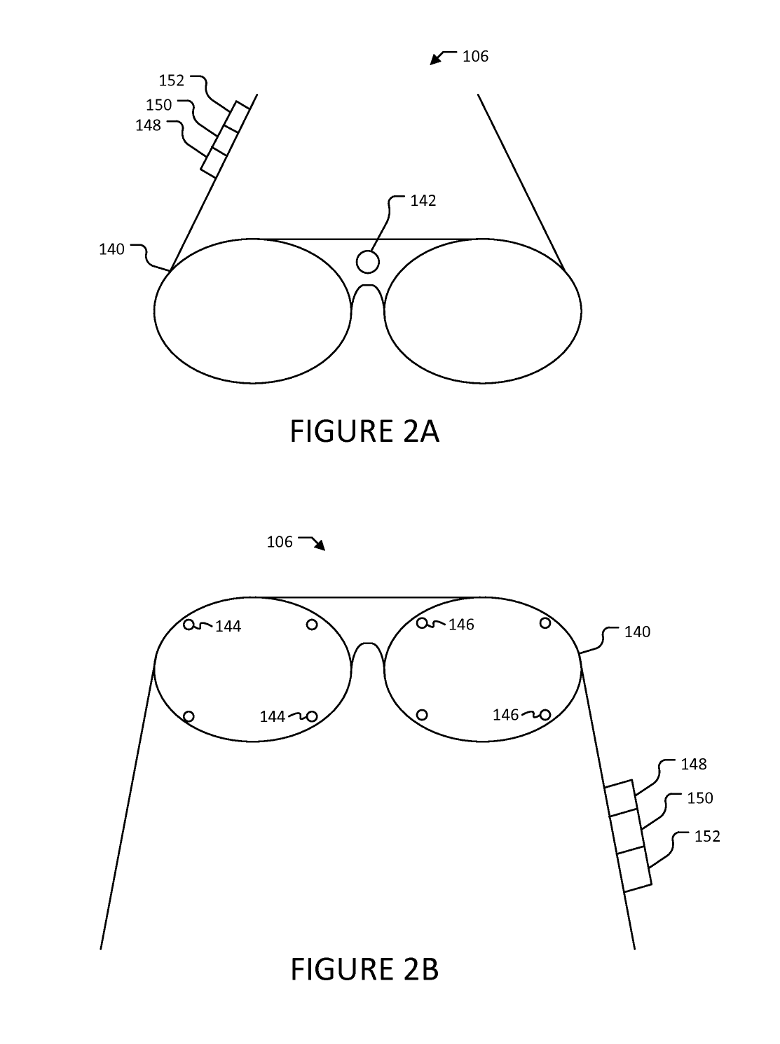

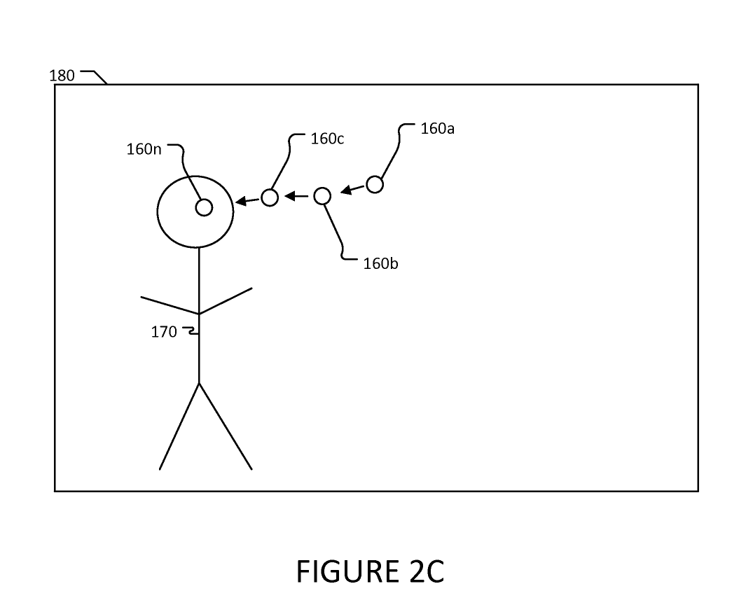

Referring to FIGS. 2A-2B, detailed diagrams of the eye tracking device 106 are illustrated. FIG. 2A is a front view of one embodiment of the eye tracking device 106. FIG. 2B is a back view of the eye tracking device 106. The eye tracking device 106 can be implemented to track where a trainee is looking while watching and interacting with a training scenario. Generally, the eye tracking device 106 can include a frame 140, a front video camera 142, a left eye tracking sensor 144, a right eye tracking sensor 146, a network interface 148, storage 150, and a control module 152.

As shown in FIG. 2A, the front video camera 142 can be attached to a front of the frame 140 to provide a first person view of what the trainee is looking at. As shown in FIG. 2B, the left eye tracking sensor 144 can be attached to a left inside of the frame to provide tracking of a left eye of the trainee. The right eye tracking sensor 146 can be attached to a right inside of the frame to provide tracking of a right eye of the trainee. In one instance, the eye tracking sensors 144, 146 can each include a plurality of cameras.

Typically, the network interface 148 can include hardwired and/or wireless interfaces through which the eye tracking device 106 can communicate with the simulator system 104. In one embodiment, the storage 150 can be random access memory. In another embodiment, the storage 150 can be a nonvolatile storage. In some embodiments, the storage 150 can include both random access memory and nonvolatile storage.

In one embodiment, the eye tracking device 106 can include the control module 152. The control module 152 can be adapted to run software including, but not limited to, one or more applications or programs. The eye tracking device 106 can generally include software for compiling video from the front camera 142 with data from the eye tracking sensors 144, 146. Generally, the eye tracking sensors 144, 146 can provide coordinate data for generating a point-of-focus marker 160. The point-of-focus marker 160 can be a digital icon showing where a wearer's eyes are focused. For instance, the coordinate data can be compiled with the video from the front camera 142 to show where a wearer was focusing at any given moment.

Referring to FIG. 2C, a graphical representation of a few frames 180 of a point-of-view video recorded with the eye tracking glasses 106 is illustrated. The point-of-focus marker 160 is shown moving from a first point-of-focus 160a to an n^{th} point-of-focus 160n as a wearer changes their focus from a center of the frame to a perpetrator 170 on the left side of the frame. Generally, the point-of-focus marker 160 can be implemented to show where a wearer's focus was while watching a training scenario. As can be appreciated, the perpetrator 170 would be part of a training scenario being displayed to the wearer. The video frames 180 would be coming from the point-of-view video created by the eye tracking glasses 106.

Typically, the eye tracking device 106 can be connected to the simulator system 104 to send data and/or information from the eye tracking device 106 to the simulator system 104. For instance, the eye tracking device 106 can be wirelessly connected to the simulator system 104.

In one embodiment, the eye tracking device 106 can send a video stream from the front video camera 142 to the simulator system 104. Depending on the type of storage included with the eye tracking device 106, the simulator system 104 can record the video stream being received from the eye tracking device 106. Generally, whether the eye tracking device 106 or the simulator system 104 initially stores the video from the front camera 142, the simulator system 104 will end up storing a copy of the video from the front camera 142.

Typically, in embodiments where the eye tracking device 106 does not include a control module, the coordinate data generated by the eye tracking sensors 144, 146 can be sent to the simulator system 104. The simulator system 104 can include software, operated by the control module 120, to compile the video from the front camera 142 with the coordinate data from the eye tracking sensors 144, 146 to generate a video including the point-of-focus marker. In some embodiments, data from the eye tracking sensors 144, 146 can be sent to the simulator system 104 even when the eye tracking device 106 compiles the video with the point-of-focus marker.

The eye tracking device 106 can include, but is not limited to, devices adapted to track eye movement of a wearer and also devices adapted to stream video of what a wearer is looking at. In some instances, the eye tracking device 106 can perform both functions. In one embodiment, the eye tracking device 106 can be “SMI Eye Tracking Glasses 2 Wireless” manufactured by SensoMotoric Instruments. In another embodiment, the eye tracking device 106 can be “Tobii Pro Glasses 2” manufactured by Tobii Pro. It is to be appreciated that other versions or types of eye tracking glasses can be implemented in the present training system.

### A First Method of Implementing a Use of Force Training System

Referring to FIG. 3, a flow chart illustrating a method or process 200 for implementing a use of force training system is illustrated. The process 200 is one example of implementing the previously disclosed weapon 102, the simulator system 104, and the eye tracking device 106 together as a use of force training system.

In block 202, the use of force training system 100 can be set up. After the simulator system 104 has been set up, the weapon 102 and the eye tracking device 106 can both be calibrated with the simulator system 104. Typically, a trainee can be fitted with the eye tracking device 106 and be provided the weapon 102.

In block 204, the simulator system 104 can be implemented to display a training scenario. In one embodiment, the training scenario can be projected onto a life size screen. The simulator system 104 can include a plurality of training scenarios adapted to test a trainee. Generally, the training scenario can follow a plurality of different paths, each path including a video segment, depending on how a user interacts with the training scenario. For instance, the training scenario can branch from one video segment to another video segment depending on whether after trainee pulls the trigger 112 of the weapon 102, the simulator system 104 determines whether the shot was a hit or miss. In one example, if a proper response to a training scenario calls for the trainee to pull the trigger and fire at a perpetrator and the simulator system 104 determines the shot hit the perpetrator, the training scenario can branch to a video segment of the perpetrator being taken down. It is to be appreciated that the training scenario can branch to another video segment if the simulator system determines the trainee missed the perpetrator.

In block 206, the eye tracking device 106 can stream a video compiled from the front camera 142 and the eye tracking cameras 144, 146 of the eye tracking device 106. The streamed video can be a point-of-view perspective from the trainee including a point-of-focus marker generated from the eye tracking cameras 144, 146. In one instance, the eye tracking device 106 can live stream the compiled video to the simulator system 104. In another instance, the eye tracking device 106 can record a video compiled from the front camera 142 and eye tracking cameras 144, 16 and send the recorded video to the simulator system 104. Typically, the point-of-focus marker can be a graphical marker or icon embedded in the recorded video to denote where a trainee was focusing during the training scenario.

After the training scenario has completed, the recorded video from the eye tracking device 106 can be synced with the training video displayed during the training scenario in block 208. In one instance, the two videos can be synced and the recorded video from the eye tracking device 106 can be displayed as a picture-in-picture on the display of the simulator system 104.

In block 210, an instructor can provide feedback to the trainee based on the recorded point-of-view video. For instance, the instructor may play back the training scenario with the recorded point-of-view video being played simultaneously. The instructor can then provide feedback to the trainee based on where the trainee was looking during the entire training scenario. In one example, the training scenario may include a visual distraction meant to take a trainee's eyes off of a threat. During the playback, the instructor can provide visual feedback to the trainee to help show instances of where the trainee was not looking to where he was supposed to be looking.

### A Second Method of Implementing a Use of Force Training System

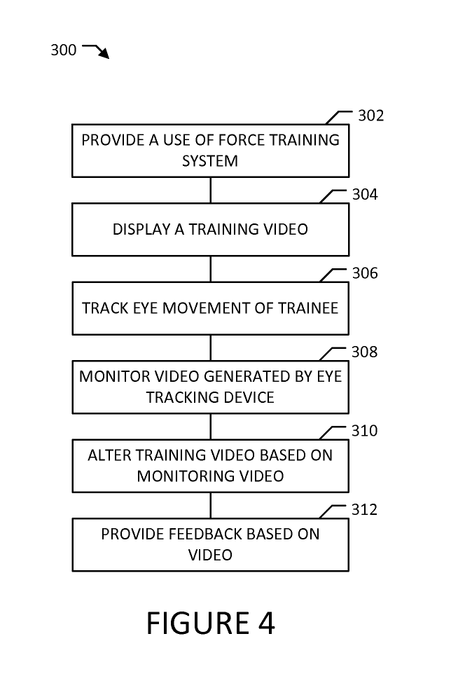

Referring to FIG. 4, a flow chart illustrating a second method or process 300 for implementing a use of force training system is illustrated. The method 300 is one example of implementing the previously disclosed weapon 102, simulator system 104, and eye tracking device 106 together as a use of force training system.

In block 302, the use of force training system 100 can be set up. After the simulator system 104 has been set up, the weapon 102 and the eye tracking device 106 can both be calibrated with the simulator system 104. Typically, a trainee can be fitted with the eye tracking device 106 and be provided the weapon 102.

In block 304, the simulator system 104 can be implemented to display a training scenario video. In one embodiment, the training scenario can be projected onto a life size screen. The simulator system 104 can include a plurality of training scenarios adapted to test a trainee. Generally, the training scenario can follow a plurality of different paths, each path including a video segment, depending on how the trainee interacts with the training scenario.

In block 306, the eye tracking device 106 can be implemented to track movement of a left eye and a right eye of a trainee. For instance, the eye tracking cameras 144, 146 can be implemented to track the left and right eyes of the trainee. Generally, the eye tracking device 106 can include software to create a point-of-focus marker from tracking movement of the left and right eyes. The software can further be adapted to merge the point-of-focus marker with video recorded from the front facing camera 142 of the eye tracking device 106.

In block 308, an instructor can monitor a video generated by the eye tracking device 106. For instance, the eye tracking device 106 can live stream the video to the simulator system 104 and the video can be displayed on a monitor of the simulator system 104. Typically, the streamed video can include a point-of-view perspective from the trainee. The streamed video can further include a point-of-focus marker generated from the eye tracking cameras 144, 146. The point-of-focus marker can be a graphical marker embedded in the recorded video to denote where a trainee was focusing while watching the training scenario. For instance, the point-of-focus marker can show where a trainee was focusing during key moments of the training scenario. For example, the point-of-focus marker may show that a trainee was looking at one suspect too long while another suspect made a threatening move leading to both suspects gaining a tactical advantage over the trainee.

In block 310, the instructor can manually alter the training scenario video from one video segment to another video segment based on monitoring the video from the eye tracking device 106. Typically, the instructor can monitor the point-of-focus marker to determine if the trainee's focus warrants an action. For instance, the instructor may alter the training scenario video based on the trainee missing a suspect pulling a weapon.

After the training scenario video has concluded, the instructor can provide feedback to the trainee based on monitoring the streaming video in block 312. In one instance, the instructor may play back the training scenario with the recorded point-of-view video being played simultaneously. The instructor can then provide feedback to the trainee based on where the trainee was looking during the entire training scenario.

### A Third Method of Implementing a Use of Force Training System

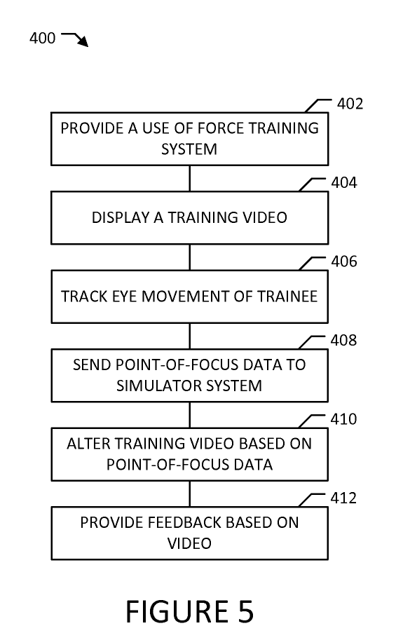

Referring to FIG. 5, a flow chart illustrating a third method or process 400 for implementing a use of force training system is illustrated. The method 400 is one example of implementing the previously disclosed weapon 102, simulator system 104, and eye tracking device 106 together as a use of force training system. Typically, the third method 400 can implement automated branching of training videos based on information and/or data received from the eye tracking device 106.

In block 402, the use of force training system 100 can be set up. After the simulator system 104 has been set up, the weapon 102 and the eye tracking device 106 can both be calibrated with the simulator system 104. Typically, a trainee can be fitted with the eye tracking device 106 and be provided the weapon 102 after the simulator system 104 is setup.

In one embodiment, the eye tracking device 106 can be calibrated to determine where the point-of-focus marker is in relation to the life size screen of the simulator system 104. The eye tracking device 106 can then send real time data to the simulator system 104 regarding where the point-of-focus of the trainee is. The simulator system 104 can receive the data and determine if the point-of-focus marker indicates that the training scenario video should be branched.

In block 404, the simulator system 104 can be implemented to display a training scenario video. In one embodiment, the training scenario can be projected onto a life size screen. The simulator system 104 can include a plurality of training scenarios adapted to test a trainee. Generally, the training scenario can follow a plurality of different paths, each path including a video segment, depending on how the trainee interacts with the training scenario.

In block 406, the eye tracking device 106 can be implemented to track a left eye and a right eye of a trainee. For instance, the eye tracking cameras 144, 146 can be implemented to track the eyes of the trainee. Typically, the eye tracking cameras 144, 146 can determine a point-of-focus of a trainee wearing the eye tracking device 106. The eye tracking device 106 can include software to generate a point-of-focus marker to visually show where a trainee's eyes are focused. Data indicating where the point-of-focus marker is in relation to the training video can be sent from the eye tracking device 106 to the simulator system 104. In one embodiment, the simulator system 104 can receive data including information about the point-of-focus of the trainee and then extrapolate that data to match the training video. The simulator system 104 can then interpret the data to determine if the training scenario video should be branched.

In block 408, the eye tracking device 106 can send data related to the point-of-focus marker to the simulator system 104. For instance, the eye tracking device 106 can continuously send data related to the point-of-focus marker to the simulator system 104 as the point-of-focus marker will constantly change based on where the trainee's eyes are focused.

In block 410, the simulator system 104 can alter the training scenario video from one video segment to another video segment based on point-of-focus data received from the eye tracking device 106. Typically, the simulator system 104 can monitor the point-of-focus data to determine if the training scenario video should be branched. For instance, the simulator system 104 may alter the training scenario video based on several instances of point-of-focus data that indicate the trainee is distracted. The simulator system 104 can then alter the training scenario video from one video segment to another video segment.

After the training scenario has concluded, the instructor can provide feedback to the trainee based on a recorded video including a point-of-view video and the point-of-focus marker in block 412. In one instance, the instructor may play back the training scenario with the recorded point-of-view video being played simultaneously. The instructor can then provide feedback to the trainee based on where the trainee was looking during the entire training scenario.

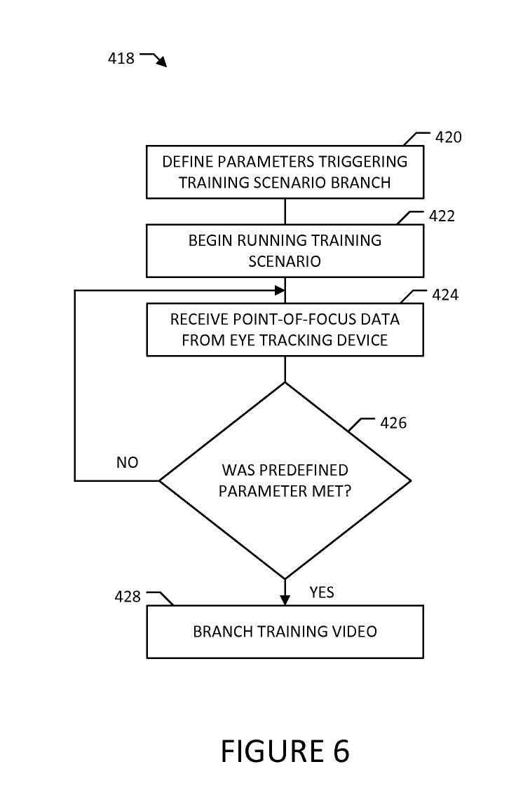

Referring to FIG. 6, a flow chart illustrating one example of a method or process 418 for implementing the simulator system 104 to branch a training video is shown. It is to be appreciated that the method 418 provided in FIG. 6 is one of many ways to implement the simulator system 104 to automatically branch the training video based on data from the eye tracking device 106.

In a block 420, one or more parameters can be defined that when met will automatically trigger the simulator system 104 to branch the training video. For instance, a parameter may include a set amount of time a trainee has to focus in on a threat presented in the training video. If the simulator system 104 receives data from the eye tracking device 106 that indicates the trainee has not located the threat in the set amount of time, the simulator system 104 can automatically branch the training video based on that data. It is to be appreciated that the parameters defined in block 420 can be based on input from one or more instructors to aid training a trainee watching and interacting with the training video.

In block 422, the training video can be started. Once the training video has begun, the eye tracking device 106 can continuously send data indicating where the trainee's point-of-focus is.

Once the eye tracking device 106 begins transmitting data, the simulator system 104 can receive the data and begin analyzing the data. Typically, after each data set is sent to the simulator system 104, the simulator system 104 can determine if a predefined parameter has been met in decision block 426. It is to be appreciated that the data from the eye tracking device 106 can be sent in set intervals and/or continuously as a live data feed.

If a predefined parameter is found to have been met, then the process 418 can move to block 428. In block 428, the training video can be branched from one video segment to another video segment based on the simulator system 104 determining that the predefined parameter was met.

If the simulator system 104 determines that no predefined parameter has been met, the process can move back to block 424. The process 418 can be repeated until the training scenario has ended.

### An Example Method of Implementing a Use of Force Training System

An example method or process for implementing the use of force training system 100 is described hereinafter. The example method includes how the previously disclosed weapon 102, simulator system 104, and eye tracking device 106 can be implemented together.

Generally, the weapon 102 can be marked and/or colored to indicate that the weapon 102 is intended for training purposes. The weapon 102 can be outfitted with the at least one laser 110 and include the trigger 112 for activating the laser 110. For instance, if the weapon 102 is a firearm, the barrel of the firearm can be outfitted with the laser 110. The laser 110 can be operatively coupled to the trigger of the firearm such that when the trigger is pulled, the laser 110 is activated. Typically, the laser 110 can be adapted to generate a pulse of light for a set amount of time. For instance, the pulse of light generated by the laser 110 can last 8 ms. It is to be appreciated that the amount of time the pulse of light lasts can vary without exceeding a scope of the present invention.

To determine between weapons being implemented, the simulator system 104 can be adapted to discern based on pulse lengths configured for each weapon. For instance, a first weapon with a first laser can be calibrated to fire a pulse of light lasting 108 ms. A second weapon with a second laser can be calibrated to fire a pulse of light lasting 74 ms. As such, two weapons can be implemented in a training scenario and the simulator system 104 can discern between the two weapons. It is to be appreciated that the pulse lengths provided are for illustrative purposes only and not meant to be limiting.

The simulator system 104 can be adapted to determine if the laser 110 from the weapon 102 hit a target by implementing the sensor 124. Generally, the sensor 124 can be adapted to detect an approximate location of where the pulse of light hit a display of the simulator system 104. In one embodiment, the simulator system 104 can include an application or program that can determine if the sensor detected the pulse of light in a predetermined area on the display.

Typically, the simulator system 104 can include a plurality of training scenarios adapted to test various protocols while responding to different scenarios. The training scenario can follow a plurality of different paths, with each path including a video segment, depending on how a trainee interacts with the weapon 102, the simulator system 104, and/or the eye tracking device 106. For instance, the training scenario can branch to one of three video segments depending on whether the trainee pulls their weapon, fires their weapon, or does not react soon enough to a threat. If the situation calls for the trainee to pull the trigger of the weapon and fire at a perpetrator, and if the simulator system 104 determines the shot hit the perpetrator, the training scenario can branch to a video segment of the perpetrator being taken down. The training scenario can branch to other video segments if the user misses the perpetrator or did not react soon enough to the perpetrator.

Depending on the embodiment, the simulator system 104 or an instructor can monitor a video feed from the eye tracking device 106 to determine if a trainee is not focusing where they should be. For instance, an instructor watching the video feed may notice that the trainee is continuously moving his focus from a main threat to his partner. The instructor may then branch the video to the perpetrator pulling and firing a gun when the trainee's focus was not on the perpetrator. Alternatively, the simulator system may determine that the trainee is focused on a possible weapon being held by the perpetrator and branch the training scenario to a video of the perpetrator not pulling the weapon since the trainee noticed the weapon and was ready to act if the perpetrator pulled the weapon.

To monitor the video feed, the simulator system 104 can continuously receive data from the eye tracking device 106 indicating where the trainee's point-of-focus is. The simulator system 104 can include software to coordinate the point-of-focus data with the training scenario video to determine if action is warranted based on where the trainee's point-of-focus is.

### A Second Embodiment of a Use of Force Training System

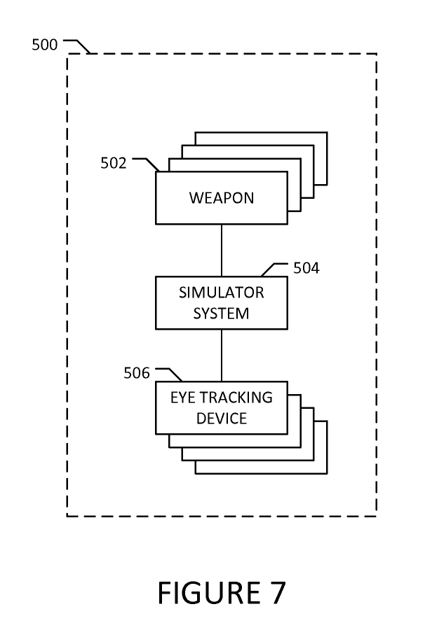

Referring to FIG. 7, a block diagram of a second embodiment 500 of a use of force training system is illustrated. Generally, the second embodiment use of force training system 500 can be implemented for training a plurality of users on how to properly use one or more different types of weapons. In one embodiment, the training system 500 can be implemented to train a plurality of users, where each of the users has at least one weapon.

As shown in FIG. 7, the use of force training system 500 can include a plurality of weapons 502, a simulator system 504, and a plurality of eye tracking devices 506.

Typically, the second embodiment use of force training system 500 can be implemented with a plurality of trainees. In one example, a first trainee can be outfitted with a first weapon, a second weapon, and a first eye tracking device. A second trainee can be outfitted with a third weapon and a second eye tracking device. Typically, the first weapon, the second weapon, and the third weapon can each include a laser generating a pulse of light for differing amounts of time. By having differing pulse lengths, the simulator system 504 can be adapted to tell between weapons by determining the length of pulse for each laser detected. As such, the simulator system 104 can tell which weapon was being fired and who the weapon was assigned to.

The eye tracking devices 506 can be adapted to send video feeds to the simulator system 504. The simulator system 504 can store the video feeds for replay at a later time. For instance, the stored video feeds can be replayed while an instructor provides feedback to the plurality of trainees. In one embodiment, each of the eye tracking devices 506 can generate a point-of-focus marker. Each of the point-of-focus markers can be assigned a different color such that an instructor can discern between trainees while watching the video feeds. In one embodiment, the simulator system 504 can merge video from each eye tracking device and output a single video including point-of-focus markers for each trainee.

The simulator system 504 can be adapted to run a training scenario and display the training scenario on a near life size screen. The training scenario can include a plurality of video segments. Typically, the training scenario can include one or more predetermined paths that the training scenario will follow. For instance, the training scenario can branch to a specific video segment based on a predetermined path the training scenario was designed to follow. As previously discussed, the simulator system 504 can branch from one video segment to another video segment based on different interactions from the trainees with the simulator system 504.

As described previously, the simulator system 504 can be adapted to alter a training scenario based on data and/or information received from any one of the plurality of eye tracking devices 506. For instance, a training scenario may have a predefined parameter for triggering a branch in the training scenario. If the simulator system 504 receives data from one of the eye tracking devices 506 that meet the parameter, the simulator system 504 can automatically branch the training scenario to a predetermined video segment based on the eye tracking device data.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A method of implementing an eye tracking device in a use of force training system, the method comprising:
providing a use of force training system, the use of force training system including:
a weapon having at least one laser;
an eye tracking device; and
a simulator system (i) operatively connected to the eye tracking device, and (ii) adapted to detect pulses of light generated by the weapon;
displaying a training video to a trainee outfitted with the eye tracking device and the weapon;
recording a video with the eye tracking device from a point-of-view of the trainee while the trainee watches the training video; and
providing feedback to the trainee based on the recorded point-of-view video.

2. The method of claim 1, wherein the step of providing feedback to the trainee based on the recorded point-of-view video includes:
playing back the training video concurrently with the recorded point-of-view video.

3. The method of claim 1, wherein before the step of providing feedback the method includes the steps of:
syncing the training video with the recorded video; and
displaying the recorded video concurrently with the training video.

4. The method of claim 3, wherein the recorded video is displayed as a picture-in-picture by the use of force training system while the training video is played.

5. The method of claim 1, wherein the eye tracking device includes:
a frame;
a front facing video camera;
at least one left eye tracking sensor; and
at least one right eye tracking sensor.

6. The method of claim 5, wherein (i) the recorded point-of-view video is compiled from the front facing video camera, the at least one eye tracking sensor, and the at least one right eye tracking sensor, and (ii) the recorded point-of-view video includes a point-of-focus marker.

7. The method of claim 1, wherein the simulator system includes:
a display for displaying the training video;
a sensor for detecting pulses of light generated by the at least one laser; and
the training video, wherein the training video includes a plurality of video segments.

8. The method of claim 7, wherein the simulator system alters the training video based on the sensor detecting a pulse of light generated by the at least one laser.

9. The method of claim 8, wherein the training video is altered by branching from one video segment to another video segment.

10. The method of claim 7, wherein the simulator system alters the training video based on a signal received from the eye tracking device.

11. A method of implementing an eye tracking device in a use of force training system, the method comprising:
providing a use of force training system, the use of force training system including:
a weapon having at least one laser;
an eye tracking device; and
a simulator system adapted to (i) detect pulses of light generated by the at least one laser, and (ii) receive and store video generated by the eye tracking device;
displaying a training video to a trainee outfitted with the eye tracking device and the weapon;
tracking an eye movement of the trainee while the trainee watches the training video;
monitoring a video generated by the eye tracking device; and
altering the training video from one video segment to another video segment based on monitoring the video.

12. The method of claim 11, wherein the step of monitoring the video is performed by an instructor.

13. The method of claim 11, wherein the video generated by the eye tracking device includes a point-of-focus marker.

14. The method of claim 13, further comprising the step of:
providing feedback to the trainee based on the point-of-focus marker.

15. The method of claim 11, further comprising the step of:
providing feedback to the trainee based on the video generated by the eye tracking device.

16. The method of claim 11, wherein the eye tracking device includes:
a frame;
a front facing video camera;
at least one left eye tracking sensor; and
at least one right eye tracking sensor.

17. A method of implementing an eye tracking device in a use of force training system, the method comprising:
providing a use of force training system, the use of force training system including:
a weapon having at least one laser;
an eye tracking device; and
a simulator system adapted to (i) detect pulses of light generated by the at least one laser, and (ii) receive data generated by the eye tracking device;
displaying a training video to a trainee outfitted with the eye tracking device and the weapon;
tracking eye movement of the trainee while the trainee watches the training video;
sending data to the simulator system from the eye tracking device; and
altering the training video from one video segment to another video segment based on the data from the eye tracking device.

18. The method of claim 17, wherein the data includes information related to where eyes of a trainee are focused in relation to the training video.

19. The method of claim 17, further comprising the step of:
providing feedback to the trainee based on the data sent to the simulator system by the eye tracking device.

20. The method of claim 17, wherein the data generated by the eye tracking device includes a point-of-focus marker.
